(19) United States
(12) Patent Application Publication
(10) Pub. No.: US 2003/0147157 A1
(43) Pub. Date: Aug. 7, 2003

(54) Optical glass for prism, process for the production thereof, and optical part for prism

(76) Inventors: Yoichiro Kamimura, Tokyo (JP); Yoichi Hachitani, Tokyo (JP); Reiko Kudo, Tokyo (JP); Kazuo Tachiwana, Tokyo (JP)

Correspondence Address: NIXON & VANDERHYE, PC, 1100 N GLEBE ROAD, 8TH FLOOR, ARLINGTON, VA, 22201-4714, US

(21) Appl. No.: 10/354,176

(22) Filed: Jan. 30, 2003

(30) Foreign Application Priority Data
Jan. 30, 2002 (JP) 2002-21980

(51) Int. Cl. G02F 1/01; G02B 5/04; G02B 7/18

(52) U.S. Cl. 359/831

(57) ABSTRACT

An optical glass for a prism, which has high transmittance, high homogeneity and excellent thermal stability, and an optical part for a prism, which is formed of the optical glass, the optical glass being an optical glass (1) wherein the absolute value of KΔt represented by the relational expression (I),

$$K Δ t = [ ( specific heat \times specific gravity ) / thermal conductivity ] \times Young ' s modulus \times thermal expansion coefficient \times ( 1 - Poisson ' s ratio ) \times photoelastic constant \qquad ( I )$$

is less than 3,000×10⁻² m·s/(g·K), and (1) which contains SiO₂ and B₂O₃ as essential components and substantially contains none of PbO and P₂O₅, (2) which comprises, by mol %, 60 to 85% of SiO₂, 5 to 20% of B₂O₃, 0 to 3% of Al₂O₃, 0 to 3% of Li₂O, 5 to 20% of Na₂O, 0 to 5% of K₂O, the total content of Li₂O+Na₂O+K₂O being 6 to 20%, 0 to 5% of MgO, 0 to 10% of CaO, 0 to 10% of SrO, 0 to 10% of BaO and 0 to 10% of ZnO, the total content of MgO+CaO+SrO+BaO+ZnO being 0.1 to 15%, and substantially contains no PbO, or (3) which has a photoelastic constant of at least 2.9×10⁻¹²/Pa, and the optical part being a glass block formed of the above optical glass.

### BACKGROUND OF THE INVENTION

1. Field of the Invention

The present invention relates to an optical glass for a prism, a process for the production thereof and an optical part for a prism. More specifically, the present invention relates to an optical glass for a prism, which is suitable for a prism, particularly suitable for a prism for a liquid crystal projector, and is excellent in high transmittance, high homogeneity and thermal stability of optical properties, a process for the production thereof, an optical part for a prism, which is formed of the above optical glass, a prism having the above optical part, and a liquid crystal projector having the prism.

2. Prior Art

A liquid crystal projector for which the demand is increasing in recent years generally employs a method in which light emitted from a high-brightness lamp is separated into lights in three colors of RGB with a dichroic mirror, and the lights in three colors are transmitted through a liquid crystal panel, synthesized with a prism and projected. The above prism is formed of four triangle-pole-shaped glasses. For accurately synthesizing lights in the three colors, not only the glasses are naturally required to be consistent in optical properties, but also the four triangle-pole-shaped members are required to be consistent in optical properties. For this purpose, the glass for the prism is required to be an optical glass that can be produced with remarkably high homogeneity. As a prism glass for a liquid crystal projector, therefore, BK7 or BSC7 (to be together referred to as “BK7” hereinafter) acknowledged as having high transmittance and high homogeneity is used (For example, refer to Okada “the design technology of liquid crystal projector” p.8-9 published by Tokyo Gijutsu Joho Service(30/6/1998)).

Since, however, heat is also emitted from a light source of a liquid crystal projector as well as light, and an optical part inside the projector is sometimes exposed to high temperatures. Naturally, the liquid crystal projector is also exposed to a temperature change after the start of its use. A conventional liquid crystal projector using BK7 has a problem that a projection image comes to be blurred or changes in color tone. The optical glass for a liquid crystal projector therefore comes to be required to have thermal stability of optical properties as well as high transmittance and high homogeneity.

As a glass having excellent stability of optical properties, a low-photoelasticity glass containing PbO is known. The above low-photoelasticity glass gives thermal stability. However, since PbO is a harmful substance, the incorporation of PbO into an optical glass is being suppressed in recent years. A P₂O₅-BaO-containing glass is also known as a low-photoelasticity glass. As compared with BK7, however, a phosphate material is expensive, and further, when a liquid material is used, a production cost increases. Further, the P₂O₅-BaO-containing glass also has a problem that it is poor in chemical durability and thermal shock resistance as compared with BK7. Under the present conditions, it is not easy to replace BK7 by a low-elasticity glass. In particular, a cost is a very important factor for influencing the spread of liquid crystal projectors in the future, and it is thought that liquid crystal projectors will find their way to average homes only when the cost is decreased.

### SUMMARY OF THE INVENTION

Under the circumstances, it is an object of the present invention to provide an optical glass for a prism, which has high transmittance, high homogeneity and thermal stability of optical properties suitable for a prism, particularly for a prism for a liquid crystal projector, an optical part for a prism, to which the above optical glass is applied, a process for efficiently producing the optical part, a prism having the above optical part and a liquid crystal projector having the above prism.

For achieving the above object, the present inventors have made diligent studies and have found the followings.

For imparting an optical glass for a prism with thermal stability, great efforts have been so far made to find out how the absolute value of the photoelastic constant can be brought close to zero as described above, and a glass containing PbO or P₂O₅ has been developed. In contrast, the present inventors have found the following. For improving the above thermal stability, the absolute value of KΔt represented by a specific relational expression of factors including specific heat, specific gravity, thermal conductivity, Young's modulus, thermal expansion coefficient, Poisson's ratio and photoelastic constant is made smaller than a certain value, whereby there can be obtained a desired optical glass for a prism without making the photoelastic constant small with excessive efforts.

Further, it has been found that an optical part for a prism can be efficiently obtained by melting, homogenizing and clarifying the above optical glass material in a vessel made of a specific material with a rod with a blade and shaping (molding) a molten glass.

The present invention has been completed on the basis of the above findings.

That is, the present invention provides;

(1) an optical glass for a prism, which contains SiO₂ and B₂O₃ as essential components and substantially contains none of PbO and P₂O₅ and wherein the absolute value of KΔt represented by the relational expression (I),

$$K Δ t = [ ( specific heat \times specific gravity ) / thermal conductivity ] \times Young ' s modulus \times thermal expansion coefficient \times ( 1 - Poisson ' s ratio ) \times photoelastic constant \qquad ( I )$$

is less than 3,000×10⁻² m·s/(g·K) (to be referred to as “optical glass 1” hereinafter),

(2) an optical glass for a prism, which comprises, by mol%, 60 to 85% of SiO₂, 5 to 20% of B₂O₃, 0 to 3% of Al₂O₃, 0 to 3% of Li₂O, 5 to 20% of Na₂O, 0 to 5% of K₂O, the total content of Li₂O+Na₂O+K₂O being 6 to 20%, 0 to 5% of MgO, 0 to 10% of CaO, 0 to 10% of SrO, 0 to 10% of BaO and 0 to 10% of ZnO, the total content of MgO+CaO+SrO+BaO+ZnO being 0.1 to 15%, which substantially contains no PbO, and wherein the absolute value of KΔt represented by the above relational expression (I) is less than 3,000×10⁻² m·s/(g·K) (to be referred to as “optical glass 2” hereinafter),

(3) an optical glass for a prism, which has a photoelastic constant of at least 2.9×10⁻¹²/Pa and wherein the absolute value of KΔt represented by the above relational expression (I) is less than 3,000×10⁻² m·s/(g·K) (to be referred to as “optical glass 3” hereinafter),

(4) An optical glass for a prism as recited in any one of the above (1) to (3), which has a refractive index of 1.45 to 1.65 and an Abbe's number of 60 to 70.

(5) An optical glass for a prism as recited in any one of the above (1) to (4), which has a refractive index in the range of 1.51680±0.00500 and an Abbe's number in the range of 64.2±0.5.

(6) an optical glass for a prism as recited in any one of the above (1) to (3), which has a viscosity, measured at 1,400° C., of less than 100 Pa·s,

(7) a process for the production of an optical glass for prism recited in any one of the above (1) to (3), which comprises the steps of

melting a glass material or a pre-grassified cullet in a vessel made of a refractory material having a platinum content of at least 95% by weight, to obtain a molten glass,

stirring the molten glass with a rod with a blade having a surface made of a material having a platinum content of at least 95% by weight, to homogenize the molten glass,

deaerating the molten glass to clarify the molten glass, and

molding or shaping the homogenized and clarified molten glass,

(8) an optical part for a prism, which is an optical part made of a glass block which is formed of the optical glass for a prism recited in any one of the above (1) to (3),

(9) a prism having the optical part for a prism recited in the above (8),

(10) a prism as recited in the above (9), which is a prism for a projector, and

(11) a liquid crystal projector having a prism recited in the above (10).

The refractive index will be sometimes referred to as n_{d}, and the abbe's number, as ν_{d}.

### BRIEF DESCRIPTION OF DRAWINGS

FIG. 1 is a schematic drawing for showing the constitution of a liquid crystal projector made in Example.

### PREFERRED EMBODIMENTS OF THE INVENTION

The optical glass for a prism, provided by the present invention, includes three embodiments such as an optical glass 1, an optical glass 2 and an optical glass 3. Each optical glass will be explained hereinafter.

First, the optical glass 1 contains SiO₂ and B₂O₃ as essential components, substantially contains none of PbO and P₂O₅, and satisfies the requirement that the absolute value of KΔt of represented by the relational expression (I),

$$K Δ t = [ ( specific heat \times specific gravity ) / thermal conductivity ] \times Young ' s modulus \times thermal expansion coefficient \times ( 1 - Poisson ' s ratio ) \times photoelastic constant \qquad ( I )$$

is less than 3,000×10⁻² m·s/(g·K). The above thermal expansion coefficient refers to an average thermal expansion coefficient at 50 to 100° C.

In the present invention, “substantially contains none” means that a glass does not contain any one of such components other than impurities, and “optical glass for a prism” means an optical glass for use as an optical part that constitutes a prism and is made of a glass (e.g., a prism-shaped glass block, or the like).

When the absolute value of KΔt represented by the above relational expression (I) is less than 3,000×10⁻² m·s/(g·K), the optical properties of a glass satisfying such a requirement do not easily change under a change in temperature. This is also applicable to the optical glass 2 and the optical glass 3 to be described later.

The above optical glass 1 substantially contains none of PbO and P₂O₅. Nevertheless, the optical glass 1 contains SiO₂ and B₂O₃ as essential components and satisfies the requirement that the absolute value of KΔt is smaller than the predetermined value, so that the optical glass I can realize an optical glass for a prism which optical glass is excellent in thermal stability.

The optical glass 2 is a glass which comprises, by mol %, 60 to 85% of SiO₂, 5 to 20% of B₂O₃, 0 to 3% of Al₂O₃, 0 to 3% of Li₂O, 5 to 20% of Na₂O, 0 to 5% of K₂O, the total content of Li₂O+Na₂O+K₂O being 6 to 20%, 0 to 5% of MgO, 0 to 10% of CaO, 0 to 10% of SrO, 0 to 10% of BaO and 0 to 10% of ZnO, the total content of MgO+CaO+SrO+BaO+ZnO being 0.1 to 15%, which substantially contains no PbO, and wherein the absolute value of KΔt represented by the above relational expression (I) is less than 3,000×10⁻² m·s/(g·K)

In the above optical glass 2, PbO is excluded from glass components, but the absolute value of KΔt is controlled to be smaller than the predetermined value, so that the optical glass 2 can also realize an optical glass for a prism which optical glass is excellent in thermal stability.

In addition to the above components, the optical glass 2 can contain, as an optional component, at least one component selected from the group consisting of La₂O₃, TiO₂, ZrO₂, Nb₂O₅, Cs₂O, Gd₂O₃, Sb₂O₃ and SnO₂.

The reason for limiting the composition of the optical glass 2 will be explained below. The content of each component expressed by % refers to a content based on mol %.

SiO₂ is a basic component of the glass and an essential component for determining thermal properties and chemical durability. When the content of SiO₂ is less than 60%, the glass is poor in devitrification resistance and chemical durability. When the above content exceeds 85%, it is difficult to melt the glass. The content of SiO₂ is therefore limited to 60 to 85%, and it is preferably 65 to 75%.

B₂O₃ is also a basic component of the glass, and at the same time, it is a component effective for improving the glass in meltability. When the content of B₂O₃ is less than 5%, the above effect is not much produced. When the above content exceeds 20%, the glass is poor in chemical durability. The content of B₂O₃ is therefore limited to 5 to 20%, and it is preferably 10 to 15%.

Al₂O₃ is a component effective for preventing the phase separation of a borosilicate glass. However, when the content of Al₂O₃ exceeds 3%, the glass is poor in devitrification resistance. The content of Al₂O₃ is therefore limited to 0 to 3%, and it is preferably 0.1 to 2%.

Li₂O is not any essential component but is a component effective for improving the glass in meltability. When the content of Li₂O exceeds 3%, the glass is poor in devitrification resistance. The content of Li₂O is therefore limited to 0 to 3%, and it is preferably 0 to 2%.

Na₂O is a component that is the most effective for improving the glass in meltability. When the content of Na₂O is less than 5%, it is difficult to melt the glass. When it exceeds 20%, the glass is poor in chemical durability. The content of Na₂O is therefore limited to 5 to 20%, and it is preferably 7 to 15%.

K₂O is not any essential component, but it is a component effective for improving the glass in meltability. When the content of K₂O exceeds 5%, the absolute value of KΔt comes to be large. The content of K₂O is therefore limited to 0 to 5%.

When the total content of Li₂O, Na₂O and K₂O is less than 6%, the molten glass has a high viscosity, so that it is difficult to melt the glass. When the above total amount exceeds 20%, not only the glass is poor in chemical durability, but also the absolute value of KΔt comes to be large. The total content of Li₂O, Na₂O and K₂O is therefore limited to 6 to 20%, and it is preferably 7 to 15%.

While MgO is not any essential component, it may be added for improving the glass in meltability and chemical durability. When the content of MgO exceeds 5%, however, the glass is poor in devitrification resistance. The content of MgO is therefore limited to 0 to 5%.

CaO and ZnO may be also added for improving the glass in meltability and chemical durability. When the content of each of CaO and ZnO exceeds 10%, the absolute value of KΔt comes to be large. The content of each of CaO and ZnO is therefore limited to 0 to 10%.

SrO and BaO may be also added for improving the glass in meltability and chemical durability and for adjusting the refractive index (n_{d}) and Abbe's number (ν_{d}) of the glass. The content of each of SrO and BaO is limited to 0 to 10%. Further, preferably, the total content of SrO and BaO is limited to 0 to 10%.

As already explained, BK7 has been used as a prism glass for a liquid crystal projector. The optical system of a liquid crystal projector is therefore optimized on the assumption that a prism formed of BK7 having a refractive index (n_{d}) of 1.51680 and Abbe's number (ν_{d}) of 64.2 is used. For smoothly replacing BK7 with a glass, it is desirable that the glass should have a refractive index and an Abbe's number close to the values of BK7. For bringing the refractive index (n_{d}) and Abbe's number (ν_{d}) of the optical glass 2 close to the values of BK7, it is preferred to adjust the total content of SrO and BaO to 1 to 10%, and it is more preferred to adjust the above total content to 1 to 5%

MgO, CaO, SrO, BaO and ZnO are components for improving the glass in meltability while maintaining the chemical durability. However, when the total content thereof is less than 0.1%, the above effect is small. When it exceeds 15%, the glass is poor in chemical durability and the absolute value of KΔt comes to be large. The total content of MgO, CaO, SrO, BaO and ZnO is therefore limited to 0.1 to 15%, and it is preferably 3 to 8%.

The contents of the above components may be independently in the above ranges preferred, for the above-described reasons. Above all, of the above glass compositions, more preferred is an optical glass containing 67 to 75% of SiO₂, 10 to 15% of B₂O₃, 0.1 to 2% of Al₂O₃, 0 to 2% of Li₂O and 7 to 15% of Na₂O, the total content of Li₂O+Na₂O+K₂O being 7 to 15%, the total content of MgO+CaO+SrO+BaO+ZnO being 3 to 8%.

La₂O₃, TiO₂, ZrO₂, Nb₂O₅, Cs₂O, Gd₂O₃, Sb₂O₃, SnO₂ and F are not any essential component, but may be added for improving the glass in meltability, adjusting thermal expansion properties, optical properties, clarification and improving the glass in chemical durability.

Of these, it is preferred to add Sb₂O₃ having the function of clarification.

Particularly, the above optical glass 2 preferably has a composition in which the total content of SiO₂, B₂O₃, Al₂O₃, Na₂O, Li₂O, CaO, SrO, BaO, ZnO and Sb₂O₃ is at least 95%, more preferably has a composition in which the above total content is at least 99%, and particularly preferably has a composition in which the above total content is 100%.

It is undesirable to substantially contain the following components. Such undesirable components include F and As compounds. Further, it is also desirable to exclude radioactive substances and harmful substances such as Cd.

The optical glass 3 of the present invention is a glass that has a photoelastic constant of at least 2.9×10⁻¹²/Pa, and wherein the absolute value of KΔt represented by the above relational expression (I) is less than 3,000×10⁻² m·s/g·K) . The above optical glass 3 has a larger photoelastic constant than a conventional PbO-containing glass or P₂O₅-BaO-containing glass, but the absolute value of its KΔt is controlled to be smaller than the predetermined value, so that it can realize an optical glass for a prism excellent in thermal stability.

The optical glass 1 may be a glass that also has the properties of the optical glass 2, may be glass that also has the properties of the optical glass 3, or may be a glass that also has the properties of both the optical glass 2 and the optical glass 3. Further, the optical glass 2 may be a glass that also has the properties of the optical glass 3.

The composition of each of the optical glass 1 and the optical glass 3 preferably includes the same glass composition as that of the optical glass 2.

In the optical glass of the present invention (that refers to the optical glasses 1, 2 and 3 and is used in this sense hereinafter), the absolute value of KΔt represented by the above relational expression (I) is less than 3,000×10⁻² m·s/(g·K), preferably less than 2,500×10⁻² m·s/(g·K), more preferably 2,000×10⁻² m·s/(g·K).

As already explained, it is desirable to bring the refractive index and Abbe's number of the glass close to the counterparts of BK7. In any one of the optical glasses 1 to 3, preferably, the refractive index (n_{d}) is 1.45 to 1.65, and the Abbe's number (ν_{d}) is 60 to 70, and more preferably, the refractive index (n_{d}) is in the range of 1.51680±0.00500, and the Abbe's number (ν_{d}) is in the range of 64.2±0.5. Particularly preferably, the refractive index (n_{d}) is in the range of 1.51680±0.00100, and the Abbe's number (ν_{d}) is in the range of 64.2±0.2.

Further, the specific gravity of the above optical glass is preferably adjusted to 2.50 or less, particularly preferably from 2.20 to 2.50. The absolute value of KΔt increases with the specific gravity of the glass if no other properties change. For decreasing the absolute value of KΔt on the basis of the specific gravity side, therefore, the specific gravity in the above range is preferred.

Further, the optical glass preferably has a thermal expansion coefficient, measured at 50 to 100° C., of from 28×10⁻⁷/K to 60×10⁻⁷/K. Like the specific gravity, KΔt is in proportion of the thermal expansion coefficient. When the thermal expansion coefficient is controlled to be in the above range, therefore, the glass can be not only improved in thermal stability but also improved in thermal shock resistance.

The above optical glass preferably has a viscosity, measured at 1,400° C., of less than 100 Pa·s. The viscosity of a molten glass is an important property for producing a homogeneous glass at a low cost. When the viscosity of a molten glass at 1,400° C. is 100 Pa·s or higher, the components of the glass are not easily mixed, and the glass is poor in homogeneity. For improving the homogeneity, a melting apparatus capable of melting the glass at a further higher temperature is required, and there is caused a problem that production equipment requires too much cost and increases the cost for the glass. The viscosity of the molten glass at 1,400° C. is therefore preferably adjusted to less than 100 Pa·s. The optical glass for a prism is required to have thermal stability as described above, and the homogeneity of the glass is required as a premise therefor. The above property is therefore one of important properties that an optical glass for a prism is required to have.

In this invention, a sample is measured for a viscosity of optical glass with co-axial dual cylindrical rotating viscometer according to JIS Z 8803.

Further, in the above optical glass, desirably, the content of Fe₂O₃ is controlled to be less than 50 ppm. Fe₂O₃ is a component that deteriorates the transmittance essential for the above optical glass. When the content of Fe₂O₃ is larger than 50 ppm, the glass is colored, and images change in color tone. For preventing the coloring, therefore, the content of Fe₂O₃ is controlled preferably to be less than 50 ppm, more preferably to be less than 30 ppm. When the content of Fe₂O₃ is controlled to be 20 to 30 ppm, there is generally no problem.

The above optical glass preferably has a transmittance (as a transmittance of a glass plate both surfaces of which are optically polished so that the glass has a thickness of 10 mm), measured at a wavelength of 380 nm, of at least 88%. In this case, the above transmittance at a wavelength band of 380 nm to 760 nm comes to be at least 88%.

Further, when the above optical glass is evaluated for water resistance according to the powder method of Japan Optical Glass Industry Society Standard, the water resistance by Dw expression is preferably 0.1% or less, more preferably 0.05% or less.

According to the present invention, the above optical glass for a prism can be efficiently produced by the following process.

That is, there are carried out-the steps of melting a glass material or a pre-grassified cullet in a vessel made of a refractory material having a platinum content of at least 95% by weight, to obtain a molten glass, stirring the molten glass with a rod with a blade having a surface made of a material having a platinum content of at least 95% by weight, to homogenize the molten glass, deaerating the molten glass to clarify the molten glass, and molding or shaping the homogenized and clarified molten glass, whereby the above optical glass for a prism, provided by the present invention, can be produced.

In the process of the present invention, the process for producing a homogeneous and high-quality optical glass with preventing inclusion of impurities is applied to the production of an optical glass for a prism, to produce the above optical glass.

For example, oxides, hydroxides, carbonates, nitrates, chlorides and sulfides as glass materials are used as required, weighed so as to obtain a desired composition and mixed to prepare a formulated raw material. The formulated raw material is heated in a vessel made of a refractory material having a platinum content of at least 95% by weight, to obtain a molten glass. The molten glass is stirred with a rod with a blade having surface made of a material having a platinum content of at least 95% by weight, to homogenize the molten glass, to deaerate the molten glass to remove foams therein and to clarify the molten glass, whereby a molten glass to be molded (shaped) is obtained. The thus-homogenized molten glass is cast into a frame to mold or shape it to a glass molded article, and the glass molded article is cooled in a furnace heated close to an annealing point of the glass. The above steps in the present invention are all carried out at 1,500° C. or lower. Generally, a glass classified into a hard glass is produced at a melting temperature of 1,550° C. or higher, for example, at 1,650° C. Such a glass therefore has a problem on foreign matter formed by corrosion of a heat-resistant vessel or coloring, and it is not suitable as an optical glass, particularly, a glass for a liquid crystal projector prism. The quality of the above hard glass is extremely inferior to the quality of a glass usable as a prism, particularly, a liquid crystal projector prism.

According to the present invention, the above process that is carried out with the greatest care is employed, whereby an optical part for a prism, formed of the above optical glass, can be produced without coloring the glass, including foreign matter in the glass, leaving foams in the glass or making the glass non-homogeneous.

The optical part for a prism, provided by the present invention, will be explained below. The optical part is a glass block, and the glass block is formed of the above optical glass of the present invention. The optical part may have various forms, and prism-shaped parts, particularly, trigonal-prism-shaped parts, are frequently used. The optical part of the present invention includes a part whose surfaces are not polished and a part whose surfaces, particularly, whose optical functional surfaces (surfaces that transmit and reflect light) are polished, and an optical part whose optical function surfaces are optically polished is generally used.

The optical part for a prism, provided by the present invention, uses the above optical glass of the present invention, so that there can be provided a prism excellent in thermal stability, thermal shock resistance and water resistance at a low cost. The optical part of the present invention is particularly suitable for a prism for a liquid crystal projector.

The prism of the present invention has the above optical part for a prism, and the optical function surface(s) thereof is generally optically polished. Further, an optical thin film or multi-layered film is formed on the optical function surface as required. The above thin film or multi-layered film includes an anti-reflection film, a high-reflection film and a reflection film having selectivity to wavelength(s). Further, the above prism includes a prism constituted by attaching a plurality of the above optical parts for a prism. An optical thin film or multi-layered film may be formed on an attaching surface of the optical part.

The prism for a liquid crystal projector will be explained as one embodiment below. Prisms having various forms and constitutions are used as prisms for liquid crystal projectors. The main function of the prism includes the function of separating light emitted from a light source to RGB and the function of multiplexing waves of spatially modulated RGB lights. The prism of the present invention can have various forms and constitutions depending upon an end use. Further, the optical function surface thereof may have an optical thin film or multi-layered film as required. Even in such a case, the glass block constituting the prism is formed of the above optical glass of the present invention, so that there can be provided a prism excellent in thermal stability, thermal shock resistance, water resistance, etc., at a low cost. The prism of the present invention therefore greatly serves to spread liquid crystal projectors capable of forming quality images.

The liquid crystal projector of the present invention has the above prism, and the prism is formed of the above optical glass of the present invention excellent in thermal stability, so that the liquid crystal projector of the present invention is remarkably free of distortion of projected images and can form quality images.

### EXAMPLES

The present invention will be explained further in detail with reference to Examples hereinafter, while the present invention shall not be limited by these Examples.

### Examples 1-6 and Comparative Examples 1-4

Raw materials having an optical glass grade purity were used. The raw materials such as oxides, hydroxides, carbonates, nitrates, chlorides, sulfates, etc., were weighed so as to obtain a composition shown in Table 1 or 2 and mixed to prepare a formulated material, and the formulated material was placed in a platinum crucible. The formulated material was heated and melted at 1,400-1500° C., and then, stirred with a stirring rod with a blade made of platinum to homogenize the material. Then, the homogenized material was left still for clarification and then cast into a mold. After the glass was solidified, the molded glass was transferred to an electric furnace pre-heated to the annealing point of the glass, and gradually cooled to room temperature. Test pieces necessary for measurements were taken out from the thus-obtained glass block and polished, and the test pieces were evaluated for various properties. Tables 1 and 2 show the results. The various properties were measured by the following methods. The transmittance of each of test pieces in Examples at a wavelength band of 380 to 760 nm was over a value at a wavelength of 380 nm.

(1) Thermal expansion coefficient

A test piece was measured with a thermo-mechanical analyzer (TMA, TMA8301 supplied by Rigaku K.K.) and an average linear expansion coefficient in a temperature range of from 50° C. to 100° C. was calculated.

(2) Young's modulus

A sample was measured for a propagation speed of ultrasonic wave with a sing-around acoustic velocity measuring apparatus (UVM-2 supplied by Choonpakogyo K.K.) and a Young's modulus was calculated on the basis of the following equation.

$$\begin{matrix}G = {V}_{s}^{2} \cdot ρ \\ Young ' s modulus = ( 4 {G}^{2} - 3 G \cdot {V}_{1}^{2} \cdot ρ ) / ( G - {V}_{1}^{2} \cdot ρ )\end{matrix}$$

in which G is a modulus of rigidity, Vₛ is a velocity of longitudinal wave, V₁ is a velocity of transverse wave and ρ is a density of glass.

(3) Poisson's ratio

Calculated on the basis of the following equation using Young's modulus and modulus of rigidity. The modulus of rigidity was also measured with a sing-around acoustic velocity measuring apparatus (UVM-2 supplied by Choonpakogyo K.K.) like the measurement of Young's modulus.

Poisson's ratio=(E/2G)-1

in which G is a modulus of rigidity and E is a Young's modulus.

(4) Photoelastic constant

A compressive load was applied to a disk-shaped sample in one straight-line direction, and an optical path difference caused in the center of the disk was measured using He—Ne laser beam (wavelength 632.8 nm) . The photoelastic constant was calculated on the basis of the following equation using the measurement value.

Photoelastic constant=δ/(d·F)

in which δ is an optical path difference, d is a thickness of a sample and D is a stress.

(5) Thermal conductivity

A sample was measured for a thermal conductivity at room temperature according to a laser flash method(measured by TC-7000 which is supplied by Shinkuriko K.K.).

In the laser flash method, the front surface of the sample was irradiated with a laser beam from a laser oscillator, and an amount of heat emitted from the reverse surface of the sample and a time period for which the heat was emitted were measured, to derive a specific heat (Cp) and a thermometric conductivity (α). A thermal conductivity was calculated on the basis of the following equation.

Thermal conductivity=α·Cp·ρ

in which ρ is a density of the sample.

(6) Specific heat

Measured with a specific heat measuring apparatus (SH-3000,supplied by Shinkuriko) at room temperature.

(7) Water resistance

A sample was measured by the powder method of Japan Optical Glass Industry Society Standard, and evaluated for water resistance on the basis of a Dw value.

That is, a sample was pulverized and a predetermined amount of the pulverized sample was collected. While the collected sample was immersed in pure water in a round-bottom quartz-glass flask with a condenser, the sample was heated and dried, and a weight loss (%) thereof was taken as a Dw value.

(8) Transmittance

An optically polished glass having a thickness of 10 mm was measured for a transmittance at a wavelength of 380 nm.

(9) Refractive index (n_{d}) and Abbe's number (ν_{d})

A sample was measured for a refractive index (n_{d}) and an Abbe's number (ν_{d}) by a refractive index measurement method according to Japan Optical Glass Industry Society Standard (measured by GMR-1 supplied by Karunyukogaku K.K.).

(10) Viscosity

A sample is measured for a viscosity of optical glass at 1400° C. with co-axial dual cylindrical rotating viscometer according to JIS Z 8803 (measured by high temperature viscometer RHEOTRONIC supplied by Tokyo kogyo K.K.)

TABLE 1

| | | Ex. 1 | Ex. 2 | Ex. 3 | Ex. 4 | Ex. 5 | Ex. 6 |
|---|---|---|---|---|---|---|---|
| Glass | SiO₂ | 69.0 | 70.0 | 72.0 | 78.0 | 71.0 | 70.0 |
| Compo- | B₂O₃ | 13.0 | 15.0 | 14.0 | 13.0 | 13.0 | 13.5 |
| sition | Al₂O₃ | 1.0 | 1.0 | 1.0 | 1.0 | 1.0 | 1.5 |
| (mol %) | Li₂O | 0.1 | 1.0 | 0.0 | 0.0 | 0.0 | 0.0 |
| | Na₂O | 11.0 | 6.0 | 8.0 | 7.0 | 10.0 | 10.0 |
| | K₂O | 0.0 | 0.0 | 0.0 | 0.0 | 0.0 | 0.0 |
| | MgO | 0.0 | 0.0 | 0.0 | 1.0 | 0.0 | 0.0 |
| | CaO | 2.0 | 3.0 | 2.0 | 0.0 | 3.0 | 0.0 |
| | BaO | 0.0 | 0.0 | 0.0 | 0.0 | 2.0 | 0.0 |
| | P₂O₅ | 0.0 | 0.0 | 0.0 | 0.0 | 0.0 | 0.0 |
| | PbO | 0.0 | 0.0 | 0.0 | 0.0 | 0.0 | 0.0 |
| | Fe₂O₃ | (20) | (20) | (20) | (20) | (20) | (20) |
| | (ppm) | | | | | | |
| | Total | 100 | 100 | 100 | 100 | 100 | 100 |
| | Sb₂O₃* | 0.02 | 0.02 | 0.02 | 0.0 | 0.02 | 0.02 |

| | | | | | | |
|---|---|---|---|---|---|---|
| Thermal | 5.7 | 4.8 | 4.8 | 4.1 | 6.1 | 6.2 |
| expansion | | | | | | |
| coefficient | | | | | | |
| at 50-100° C. | | | | | | |
| (×10⁻⁶/° C.) | | | | | | |
| Specific | 2.4 | 2.35 | 2.37 | 2.28 | 2.52 | 2.54 |
| gravity | | | | | | |
| Young's | 71 | 70 | 71 | 72 | 80 | 81 |
| modulus | | | | | | |
| (GPa) | | | | | | |
| Poisson's ratio | 0.2 | 0.2 | 0.2 | 0.2 | 0.2 | 0.2 |
| Photoelastic | 3.5 | 3.6 | 3.49 | 3.8 | 2.9 | 2.9 |
| constant | | | | | | |
| (×10⁻¹²/Pa) | | | | | | |
| Thermal | 1.2 | 1.2 | 1.2 | 1.2 | 1.2 | 1.2 |
| conductivity | | | | | | |
| (W/m · K) | | | | | | |
| Specific heat | 0.74 | 0.74 | 0.74 | 0.74 | 0.74 | 0.74 |
| (J/g · k) | | | | | | |
| KΔt | 2639 | 2191 | 2173 | 1971 | 2725 | 2850 |
| (×10⁻² m · s/ | | | | | | |
| (g · K) ) | | | | | | |
| Dw (%) | <0.01 | <0.01 | <0.01 | <0.01 | <0.01 | <0.01 |
| Transmittance | 90 | 91 | 91 | 90 | 90 | 90 |
| at wavelength | | | | | | |
| of 380 nm (%) | | | | | | |
| Refractive | 1.51900 | 1.51250 | 1.50820 | 1.51000 | 1.51680 | 1.51840 |
| index | | | | | | |
| (n_{d}) | | | | | | |
| Abbe's number | 62.50 | 63.80 | 63.40 | 64.50 | 64.20 | 64.10 |
| (V_{d}) | | | | | | |
| Viscosity of | 10 | 30 | 20 | 30 | 10 | 10 |
| optical glass at | | | | | | |
| 1400° C. | | | | | | |
| (Pa · S) | | | | | | |

Ex. = Example
*The amount of Sb₂O₃ is an amount (part by weight) based on the total amount (100 parts by weight) of SiO₂ to Fe₂O₃.

TABLE 2

| | | CEx. 1 | CEx. 2 | CEx. 3 | CEx. 4 |
|---|---|---|---|---|---|
| Glass | SiO₂ | 72.0 | 82.4 | 0.0 | 54.0 |
| Compo- | B₂O₃ | 11.0 | 11.7 | 0.0 | 0.0 |
| sition | Al₂O₃ | 0.1 | 1.4 | 4.0 | 0.0 |
| (mol %) | Li₂O | 0.0 | 0.0 | 0.0 | 0.0 |
| | Na₂O | 8.9 | 4.5 | 0.0 | 1.0 |
| | K₂O | 7.0 | 0.0 | 0.0 | 1.0 |
| | MgO | 0.0 | 0.0 | 0.0 | 0.0 |
| | CaO | 0.0 | 0.0 | 0.0 | 0.0 |
| | BaO | 1.0 | 0.0 | 52.0 | 1.0 |
| | ZnO | 0.0 | 0.0 | 0.0 | 0.0 |
| | P₂O₅ | 0.0 | 0.0 | 44.0 | 0.0 |
| | PbO | 0.0 | 0.0 | 0.0 | 44.0 |
| | Fe₂O₃ (ppm) | 20.0 | 500 | 20 | 20 |
| | Total | 100.01 | 100.0 | 100.0 | 100.0 |
| | Sb₂O₃* | 0.01 | 0.00 | 0.00 | 0.00 |

| | | | | |
|---|---|---|---|---|
| Thermal expansion | 8.2 | 3 | 12.4 | 9 |
| coefficient at 50-100° C. | | | | |
| (×10⁻⁶/° C.) | | | | |
| Specific gravity | 2.52 | 2.23 | 3.84 | 5.51 |
| Young's modulus (GPa) | 79 | 63 | 52.2 | 54 |
| Poisson's ratio | 0.21 | 0.19 | 0.3 | 0.24 |
| Photoelastic constant (x10 | 2.73 | 3.95 | 0.43 | 0.02 |
| ¹²/Pa) | | | | |
| Thermal conductivity | 1.2 | 1.3 | 0.443 | 0.62 |
| (W/m · K) | | | | |
| Specific heat (J/g · k) | 0.73 | 0.74 | 0.464 | 0.36 |
| KΔt (×10² m · s/(gK) ) | 3432 | 1170 | 1599 | 41 |
| Dw (%) | 0.12 | <0.01 | 1.03 | 0.03 |
| Transmittance at | 92 | 86 | 92 | 75 |
| wavelength of 380 nm (%) | | | | |
| Viscosity of optical glass at | 10 | 150 | 1 | 20 |
| 1400° C. (Pa · s) | | | | |

CEx. = Comparative Example
*The amount of Sb₂O₃ is an amount (part by weight) based on the total amount (100 parts by weight) of SiO₂ to Fe₂O₃.

Notes: Examples 1 to 6 show glasses according to the present invention, Comparative Example 1 shows BK7, Comparative Example 2 shows a typical borosilicate glass for physical and chemical use, Comparative Example 3 shows a P₂O₅-BaO-containing low-photoelasticity glass, and Comparative Example 4 shows an SiO₂-PbO-containing low-photoelasticity glass.

In all of Examples 1 to 6, optical glasses excellent in thermal stability, thermal shock resistance and water resistance were obtained. On the other hand, the glasses in Comparative Examples had problems that they were colored, were not sufficient in thermal stability or contained environmentally undesirable substances. The glasses in Comparative Examples did not satisfy all the conditions that the optical glasses in Examples satisfied.

### Example 7

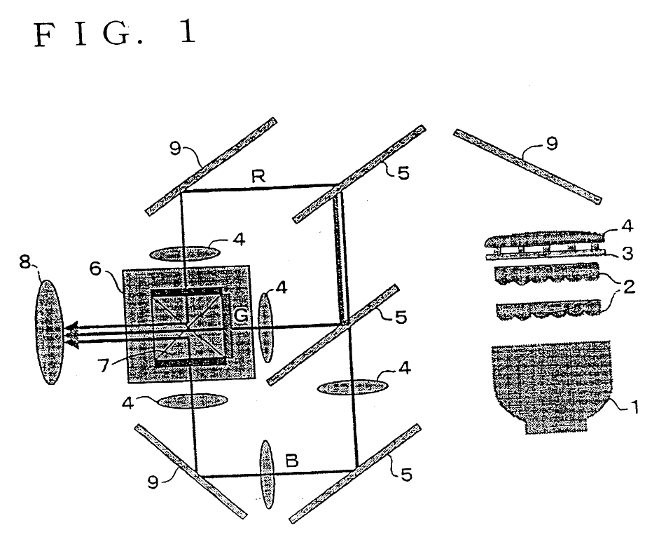

The optical glass obtained in Example 1 was polished so as to have the form of a trigonal prism, and the polished optical glass was used as an optical part for a prism. Four such optical parts for a prism were prepared, and their optical function surfaces were attached to constitute a prism for a liquid crystal projector shown in FIG. 1. An optical thin film or optical multi-layered film is formed on the optical function surfaces of the above prism as required.

The above prism was used to prepare a liquid crystal projector having a structure shown in FIG. 1. In the above projector, light emitted from a high-brightness lamp 1 is passed through an integrate lens 2, a polarized-light conversion system 3 and a condensing lens 4, and then, separated into three colors of RGB with a plurality of dichroic mirror 5. The separated lights were spatially modulated with a TFT liquid crystal panel 6 and multiplexed with the above prism 7. The multiplexed light is projected to an outside screen or the like through a projection lens 8. The prism 7 shown in FIG. 1 constitutes a unit in which the prism 7, a liquid crystal panel 6 and a dust-proof glass (not shown) are integrated. Numeral 9 shows a mirror.

The liquid crystal projector shall not be limited to the projector shown in FIG. 1, and any liquid crystal projector having a known structure can be employed.

The optical glass obtained in each of Examples 2 to 6 can also provide optical parts for a prism like the optical glass obtained in Example 1, and prisms formed of such optical parts can be also provided. Further, there can be also provided liquid crystal projectors having such prisms.

Since prisms formed of a glass obtained in Example 5 were used, prisms made of BK7 were simply replaced therewith since the refractive index (n_{d}) and the Abbe's number (ν_{d}) thereof were adjusted to the values of BK7, and that it was not at all necessary to adjust any other optical system.

### EFFECT OF THE INVENTION

According to the present invention, there can be provided an optical glass for a prism, which has high transmittance, high homogeneity and excellent thermal stability, an optical part for a prism, which is formed of the above optical glass, a process for the production of the optical part, a prism having the above optical part and a liquid crystal projector having the above prism.

According to the present invention, further, it is not required to make the photoelastic constant small with excessive efforts, so that components that may cause an environmental problem can be excluded, and that there can be provided an optical glass for a prism, an optical part for a prism and a prism, which are excellent in thermal stability, thermal shock resistance and water resistance.

What is claimed is:

1. An optical glass for a prism, which contains SiO₂ and B₂O₃ as essential components and substantially contains none of PbO and P₂O₅ and wherein the absolute value of KΔt represented by the relational expression (I),
$$K Δ t = [ ( specific heat \times specific gravity ) / thermal conductivity ] \times Young ' s modulus \times thermal expansion coefficient \times ( 1 - Poisson ' s ratio ) \times photoelastic constant \qquad ( I )$$
is less than 3,000×10⁻² m·s/(g·K).

2. An optical glass for a prism, which comprises, by mol %, 60 to 85% of SiO₂, 5 to 20% of B₂O₃, 0 to 3% of Al₂O₃, 0 to 3% of Li₂O, 5 to 20% of Na₂O, 0 to 5% of K₂O, the total content of Li₂O+Na₂O+K₂O being 6 to 20%, 0 to 5% of MgO, 0 to 10% of CaO, 0 to 10% of SrO, 0 to 10% of BaO and 0 to 10% of ZnO, the total content of MgO+CaO+SrO+BaO+ZnO being 0.1 to 15%, which substantially contains no PbO, and wherein the absolute value of KΔt represented by the relational expression (I),
$$K Δ t = [ ( specific heat \times specific gravity ) / thermal conductivity ] \times Young ' s modulus \times thermal expansion coefficient \times ( 1 - Poisson ' s ratio ) \times photoelastic constant \qquad ( I )$$
is less than 3,000×10⁻² m·s/(g·K).

3. An optical glass for a prism, which has a photoelastic constant of at least 2.9×10⁻¹²/Pa and wherein the absolute value of KΔt represented by the relational expression (I),
$$K Δ t = [ ( specific heat \times specific gravity ) / thermal conductivity ] \times Young ' s modulus \times thermal expansion coefficient \times ( 1 - Poisson ' s ratio ) \times photoelastic constant \qquad ( I )$$
is less than 3,000×10⁻² m·s/ (g·K).

4. An optical glass for a prism as recited in any one of claims 1 to 3, which has a refractive index of 1.45 to 1.65 and an Abbe's number of 60 to 70.

5. An optical glass for a prism as recited in any one of claims 1 to 3, which has a refractive index in the range of 1.51680±0.00500 and an Abbe's number in the range of 64.2±0.5.

6. An optical glass for a prism as recited in any one of claims 1 to 3, which has a viscosity, measured at 1,400° C., of less than 100 Pa·s.

7. A process for the production of an optical glass for prism recited in any one of claims 1 to 3, which comprises the steps of
melting a glass material or a pre-grassified cullet in a vessel made of a refractory material having a platinum content of at least 95% by weight, to obtain a molten glass,
stirring the molten glass with a rod with a blade having a surface made of a material having a platinum content of at least 95% by weight, to homogenize the molten glass,
deaerating the molten glass to clarify the molten glass, and
molding or shaping the homogenized and clarified molten glass.

8. An optical part for a prism, which is an optical part made of a glass block which is formed of the optical glass for a prism recited in any one of claims 1 to 3.

9. A prism having the optical part for a prism recited in claim 8.

10. A prism as recited in claim 9, which is a prism for a projector.

11. A liquid crystal projector having the prism recited in claim 10.
